(19) United States
(12) Patent Application Publication
(10) Pub. No.: US 2012/0194761 A1
(43) Pub. Date: Aug. 2, 2012

(54) LIQUID CRYSTAL MODULE AND DISPLAY DEVICE

(75) Inventor: Kodai NAKANO, Osaka (JP)

(73) Assignee: FUNAI ELECTRIC CO., LTD., Osaka (JP)

(21) Appl. No.: 13/359,175

(22) Filed: Jan. 26, 2012

(30) Foreign Application Priority Data
Jan. 28, 2011 (JP) 2011-015950

(51) Int. Cl. G02F 1/1333

(52) U.S. Cl. 349/58

(57) ABSTRACT

A liquid crystal module has a rear frame, a light source, a liquid crystal panel, and a bezel. The rear frame includes a rear panel, a first side panel, a top panel, an attachment tab and a first flange. The attachment tab is located at an end portion of the first side panel with respect to a longitudinal direction of the first side panel. The attachment tab has a base plate with a pair of opposite side edges and a fastener insertion hole. The base plate extends perpendicular to the first side panel and outward of the rear frame relative to the first side panel. The first flange extends perpendicular to the first side panel and the base plate of the attachment tab and along a first side edge of the first side panel and one of the opposite side edges of the base plate of the attachment tab.

### CROSS-REFERENCE TO RELATED APPLICATIONS

This application claims priority to Japanese Patent Application No. 2011-015950 filed on Jan. 28, 2011. The entire disclosure of Japanese Patent Application No. 2011-015950 is hereby incorporated herein by reference.

### BACKGROUND

1. Field of the Invention

The present invention generally relates to a liquid crystal module. More specifically, the present invention relates to a liquid crystal module that is used in a display device.

2. Background Information

A typical conventional liquid crystal module has a rear frame, a light source, a liquid crystal panel and a bezel. The light source is disposed inside the rear frame. The liquid crystal panel is disposed at an upper end opening of the rear frame. Four sides of the liquid crystal panel are surrounded by the bezel. The rear frame is produced by bending sheet metal into the shape of a shallow box. Attachment flanges are formed at its four corners in order to attach the liquid crystal module to a cabinet of an electronic device.

With the conventional attachment flange, an end of an upper end flange of a side panel along a long side of the rear frame is drawn to form a substantially square, concave attachment flange in which two sides on either side of a corner are open. A fastener insertion hole is punched in a bottom of the attachment flange.

Also, while not an attachment flange, there is a known liquid crystal module in which outer panels of double-walled side panels of a rear frame are cut horizontally and raised up to form bezel fixing tabs, and a bezel is fixed with fasteners to these tabs via spacers (see Japanese Laid-Open Patent Application Publication No. 2009-176544, for example).

### SUMMARY

It has been discovered that although the conventional attachment flange is formed by drawing, the strength is still somewhat lacking because the attachment flange is formed in a substantially square, concave shape in which two sides are not drawn and are open. Consequently, the conventional attachment flange is susceptible to deformation due to vibration and impact during transport. If it deforms too much, the work entailed by assembly of the liquid crystal module and attachment to the cabinet will be more difficult. Furthermore, it has also been discovered since the attachment flange is prone to deformation during the assembly of the liquid crystal module as well, the yield was poor and the cost higher.

Also, it has been discovered that, with the conventional attachment flange formed in a concave shape by drawing, it is difficult to set a large depth to the bottom where the fastener insertion hole is formed, with the limit being only about 1 cm at the deepest. Thus, another problem is that an attachment height of the liquid crystal module with respect to the cabinet of the electronic device is limited.

Meanwhile, it has also been discovered that when the outer panels of double-walled side panels of the rear frame are cut horizontally and raised up, the strength is lower than that of the conventional attachment flange formed by drawing, and deformation is more apt to occur.

An improved liquid crystal module was conceived in light of the above-mentioned problem. One object of the present disclosure is to provide a liquid crystal module with which strength of an attachment structure of a rear frame can be increased.

In accordance with one aspect of the present disclosure, a liquid crystal module has a rear frame, a light source, a liquid crystal panel, and a bezel. The rear frame includes a rear panel, a first side panel, a top panel, an attachment tab and a first flange. The rear panel has a pair of adjacent side edge portions. The first side panel extends along one of the adjacent side edge portions of the rear panel and in a forward direction of the rear frame relative to the rear panel. The top panel extends along a top edge portion of the first side panel and in an outward direction of the rear frame relative to the first side panel. The attachment tab is located at an end portion of the first side panel with respect to a longitudinal direction of the first side panel. The attachment tab has a base plate with a pair of opposite side edges and a fastener insertion hole. The base plate extends perpendicular to the first side panel and in the outward direction of the rear frame relative to the first side panel. The first flange extends perpendicular to the first side panel and the base plate of the attachment tab and along a first side edge of the first side panel and one of the opposite side edges of the base plate of the attachment tab. The light source is disposed inside of the rear frame. The liquid crystal panel is disposed on an opposite side of the light source from the rear panel. The bezel is disposed around edge portions of the liquid crystal panel.

With the liquid crystal module, it is possible to provide a liquid crystal module with which strength of an attachment structure of a rear frame can be increased.

These and other objects, features, aspects and advantages will become apparent to those skilled in the art from the following detailed description, which, taken in conjunction with the annexed drawings, discloses a preferred embodiment.

### BRIEF DESCRIPTION OF THE DRAWINGS

Referring now to the attached drawings which form a part of this original disclosure:

FIG. 1 is an exploded perspective view of a liquid crystal module in accordance with one embodiment;

FIG. 2 is a front elevational view of the liquid crystal module illustrated in FIG. 1;

FIG. 3 is a partial cross sectional view of the liquid crystal module taken along III-III line in FIG. 2;

FIG. 4 is a partial cross sectional view of the liquid crystal module taken along IV-IV line in FIG. 2;

FIG. 5 is an enlarged, partial exploded perspective view of the liquid crystal module illustrating an attachment structure of the liquid crystal module relative to a cabinet of a display device; and

FIG. 6 is a front elevational view of the display device in accordance with one embodiment.

### DETAILED DESCRIPTION OF EMBODIMENTS

A preferred embodiment will now be explained with reference to the drawings. It will be apparent to those skilled in the art from these disclosures that the following descriptions of the preferred embodiment are provided for illustration only and not for the purpose of limiting the invention as defined by the appended claims and their equivalents.

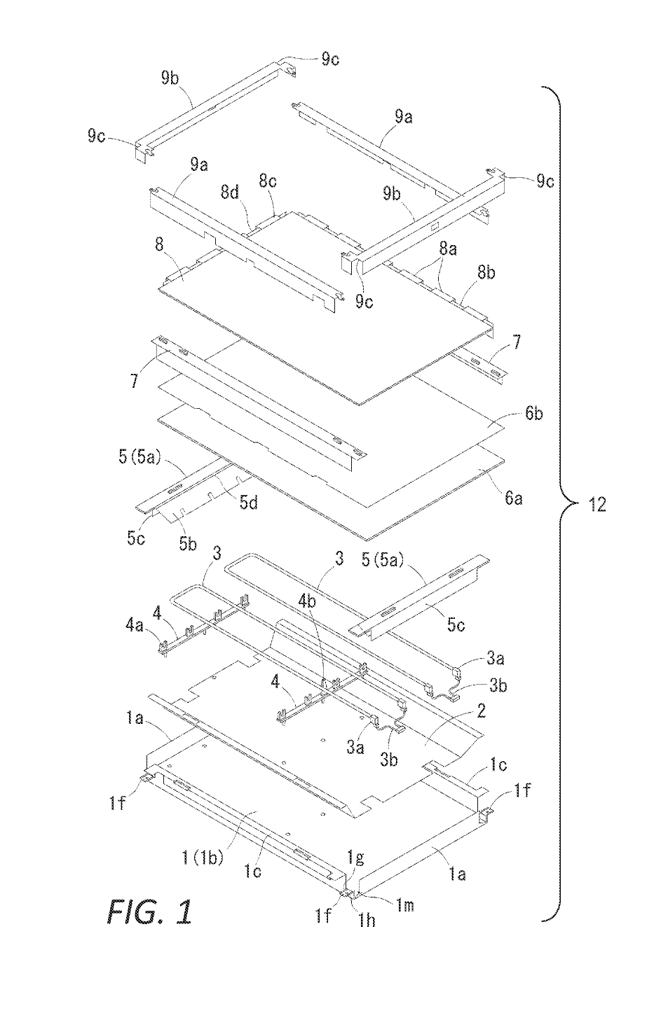

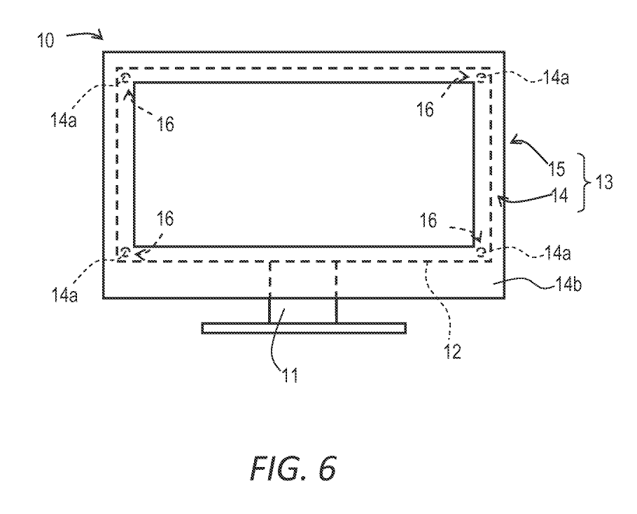

Referring to FIGS. 1 to 6, a flat panel display device 10 (e.g., display device) having a liquid crystal module 12 will now be described. As illustrated in FIG. 6, the liquid crystal module 12 is used in the flat panel display device 10. The flat panel display device 10 is used as a flat screen television set, a computer display, or other display device. The flat panel display device 10 includes a stand 11, the liquid crystal module 12 and a cabinet 13 with front and rear cabinets 14 and 15. The liquid crystal module 12 is fixed on the stand 11. The liquid crystal module 12 is covered with the cabinet 13. Specifically, the liquid crystal module 12 is disposed within an inside space of the cabinet 13 that is defined between the front cabinet 14 and the rear cabinet 15. The stand 11 is fixedly coupled to the cabinet 13. The liquid crystal module 12 is fixedly coupled to the front cabinet 14 with screws 16. The front cabinet 14 is rectangular when viewed from a front side of the flat panel display device 10, and is made of synthetic resin. The front cabinet 14 is integrally formed as a one-piece, unitary member. The front cabinet 14 has four bosses 14a and a front panel 14b. The bosses 14a have threaded holes into which the screws 16 are screwed to fixedly couple the liquid crystal module 12 to the front cabinet 14, respectively. The bosses 14a protrude rearward of the front cabinet 14 relative to the front panel 14b. The rear cabinet 15 is coupled to a rear side of the front cabinet 14, and is made of synthetic resin. The rear cabinet 15 is integrally formed as a one-piece, unitary member.

Referring to FIGS. 1 to 5, the liquid crystal module 12 will now be described further in detail. The liquid crystal module 12 is a bottom backlight type liquid crystal module. As illustrated in FIG. 1, the liquid crystal module 12 mainly includes a rear frame 1, a light reflecting sheet 2, a pair of U-shaped cold cathode tubes 3 (e.g., light sources), a pair of lamp holders 4, a pair of lamp frames 5, a plurality of optical sheets 6a and 6b, a pair of cell guides 7, a liquid crystal panel 8, and a plurality of bezels 9a and 9b.

The rear frame 1 is formed in the form of a shallow box by bending sheet metal. The rear frame 1 is integrally formed as a one-piece, unitary member. As illustrated in FIG. 1, the rear frame 1 mainly includes a pair of short side panels 1a (e.g., second side panels), a bottom panel 1b (e.g., rear panel) and a pair of double-walled long side panels 1c. The short side panels 1a extend upward (i.e., forward) from short side edge portions (e.g., the other of adjacent side edge portions) of the bottom panel 1b relative to the bottom panel 1b, respectively. The double-walled side panels 1c extend upward from long side edge portions (e.g., one of adjacent side edge portions) of the bottom panel 1b, respectively. Each of the double-walled side panels 1c includes an inner panel 1j (e.g., first side panel), a top panel 1p with an upper end flange 1e and an outer panel 1d. The inner panels 1j extend upward (i.e., forward) along the long side edge portions of the bottom panel 1b relative to the bottom panel 1b. The top panels 1p extend along top edge portions of the inner panels 1j and outward at a right angle relative to the inner panels 1j, respectively. The outer panels 1d extend downward (i.e., rearward) at a right angle relative to the top panels 1p from outer edge portions of the top panels 1p relative to the top panels 1p, respectively.

The light reflecting sheet 2 is provided on the bottom panel 1b in the interior of the rear frame 1. The U-shaped cold cathode tubes 3 are provided in parallel over the light reflecting sheet 2 in the interior or inside of the rear frame 1. The U-shaped cold cathode tubes 3 are supported by the lamp holders 4. Each of the lamp holders 4 have a plurality of holding components 4a into which the U-shaped cold cathode tubes 3 are fitted and held. One of the lamp holders 4 has a post 4b that holds up the optical sheet 6a from below and prevents sagging. The post 4b is formed on the lamp holder 4 that supports center portions of the U-shaped cold cathode tubes 3.

Lamp sockets 3a are attached to end portions of the U-shaped cold cathode tubes 3. The lamp sockets 3a are fitted into socket fitting openings (not shown) formed in the bottom panel 1b of the rear frame 1 along one of the short side panel 1a (the right side panel in FIG. 1) along one short side of the rear frame 1. Lead wires 3b of the U-shaped cold cathode tubes 3 are taken out from the lamp sockets 3a to the rear side of the rear frame 1.

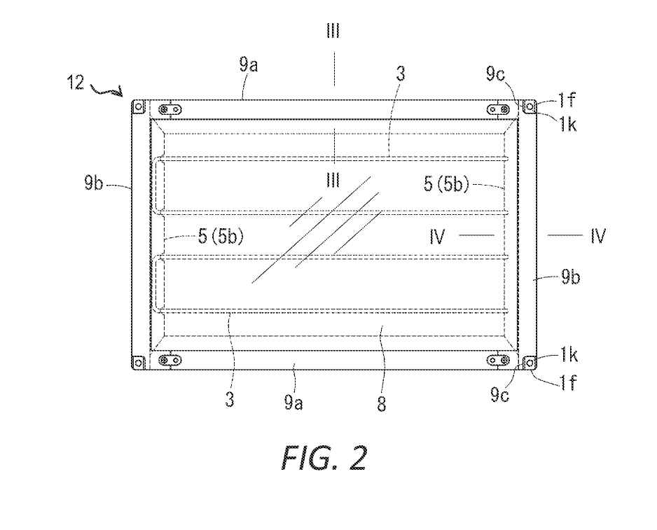

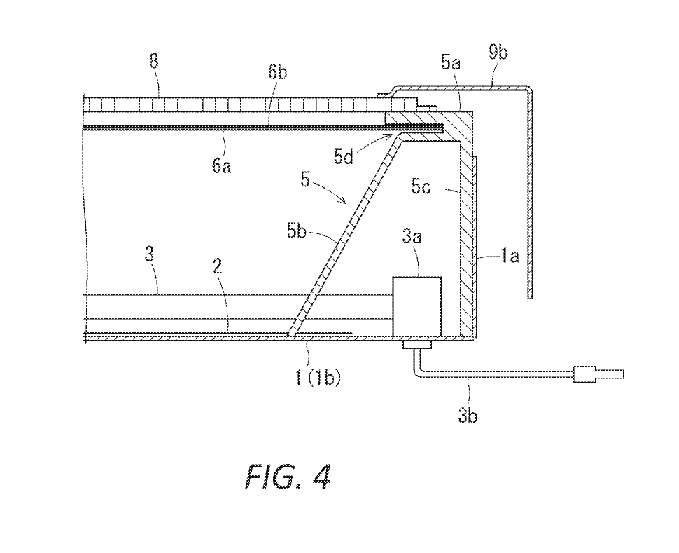

The lamp frames 5 are made of a synthetic resin. As illustrated in FIGS. 2 and 4, the lamp frames 5 disposed above the bottom panel 1b, and are attached on inside of the short side panels 1a formed on the left and right short sides of the rear frame 1. The lamp frames 5 are hollow frames. Each of the lamp frames 5 has a top panel 5a, a front inclined panel 5b, and a rear panel 5c. The lamp frames 5 hide the end portions of the U-shaped cold cathode tubes 3 where the lamp sockets 3a of the U-shaped cold cathode tubes 3 are attached, respectively, and the curved portions of the U-shaped cold cathode tubes 3 on the opposite side, which prevents uneven brightness on the left and right sides of the display face of the liquid crystal panel 8. The liquid crystal panel 8 display image on the display face. Each of the lamp frames 5 further has a groove 5d, into which are inserted edge portions of the optical sheets 6a and 6b. The grooves 5d are formed in the top panels 5a of the lamp frames 5, respectively.

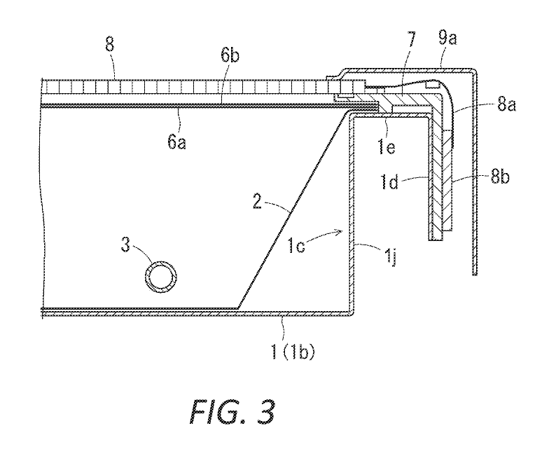

The optical sheets 6a and 6b (e.g., light diffusing sheets) are disposed at the upper end opening of the rear frame 1 above the U-shaped cold cathode tubes 3. The end edges along the long sides of these optical sheets 6a and 6b are laid on the double-walled side panels 1c. The double-walled side panels 1c are formed by bending along the long sides of the rear frame 1 in an approximately inverted U shape. As illustrated in FIG. 3, the end edges along the long sides of the optical sheets 6a and 6b are held down by the cell guides 7. The cell guides 7 are made of a synthetic resin. Furthermore, as illustrated in FIG. 4, the end edges along the short sides of the optical sheets 6a and 6b are inserted into grooves 5d formed in the top panels 5a of the lamp frames 5.

The liquid crystal panel 8 is disposed above the optical sheets 6a and 6b and the U-shaped cold cathode tubes 3. Specifically, the liquid crystal panel 8 is disposed on an opposite side of the U-shaped cold cathode tubes 3 from the bottom panel 1b. As illustrated in FIGS. 3 and 4, the four end edges (e.g., edge portions) of the liquid crystal panel 8 are disposed on the top faces of the lamp frames 5 and the cell guides 7. The liquid crystal panel 8 is disposed at the upper end opening of the rear frame 1. Four bezels 9a and 9b (e.g., two long bezels and two short bezels) made of sheet metal are linked in a square shape. The bezels 9a and 9b surround the side panels 1a and 1c on the four sides of the rear frame 1 and the four end edges on the four sides of the liquid crystal panel 8. The bezels 9a and 9b are fixed by screws to both ends of upper end flanges 1e of the double-walled side panels 1c of the rear frame 1.

As illustrated in FIGS. 1 and 3, an X-wiring board 8b is connected to the long side of the liquid crystal panel 8 is a chip-on-film 8a on which a source driver IC chip is mounted. The X-wiring board 8b is fixed to the cell guides 7 attached to the double-walled side panels 1c of the rear frame 1 as shown in FIG. 3. A Y-wiring board 8d is connected to the short side of the liquid crystal panel 8 via a chip-on-film 5c on which a gate driver IC chip is mounted. The Y-wiring board 8d is fixed to the short side panels 1a along the short sides of the rear frame 1.

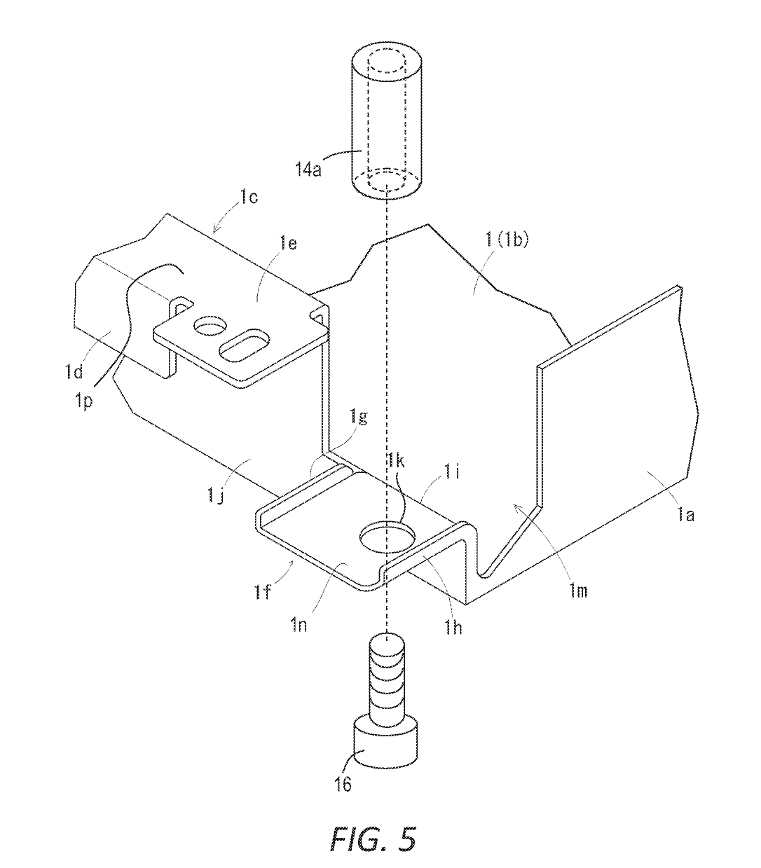

As illustrated in FIGS. 1 and 5, at both ends (e.g., longitudinal end portions) of the double-walled side panels 1c along the long sides of the rear frame 1 with respect to a longitudinal direction of the double-walled side panels 1c, the outer panels 1d and the upper end flanges 1e are notched or cut out to form attachment structures of the rear frame 1. The double-walled side panels 1c are substantially identical to each other. Hereinafter, one of the double-walled side panels 1c will be described in detail for the sake of brevity. Furthermore, the attachment structures at both ends of each of the double-walled side panels 1c are identical, except that they are mirror images of one another. Accordingly, referring to FIGS. 1 and 5, description will be provided for only one of the attachment structures, but applies equally to the other of the attachment structures. The approximate upper halves of the both ends of the inner panel 1j remaining are bent outward at a right angle to form attachment flange tabs 1f (e.g., attachment tab), respectively. The attachment flange tabs 1f are flange tabs used to attach the assembled liquid crystal module to the cabinet 13 of the flat panel display device 10. Each of the attachment flange tabs 1f has a base plate 1n with a pair of opposite side edges and a fastener insertion hole 1k. The base plate 1n extends perpendicular to the inner panel 1j and outward of the rear frame 1 relative to the inner panel 1j. The base plate 1n is located rearward of the rear frame 1 relative to the top panel 1p of the rear frame 1.

Each of the attachment flange tabs 1f further has reinforcing raised edges 1g and 1h (e.g., second and first flange) that are formed by bending at both side ends (e.g., opposite side edges) of each of the attachment flange tabs 1f. One of the raised edges 1h (e.g., first flange) is bent at a right angle at the bent portion 1i of each of the attachment flange tabs 1f, and extends downward to the end of the inner panel 1j of the double-walled side panel 1c. In other words, the raised edge 1h of each of the attachment flange tabs 1f extends perpendicular to the inner panel 1j and the base plate in of the attachment flange tab 1f and along a side edge (e.g., first side edge) of the inner panel 1j and one of the opposite side edges of the base plate in. Furthermore, the raised edge 1g (e.g., second flange) of each of the attachment flange tabs 1f is bent at a right angle relative to the base plate in, and extends perpendicular to the base plate 1n and along the other of the opposite side edges of the base plate 1n. The attachment flange tabs 1f are formed at a total of four places, one each at the two ends of the inner panels 1j of the double-walled side panels 1c.

The raised edges 1g and 1h formed at the two side edges of each of the attachment flange tabs 1f considerably increase the strength of the attachment flange tabs 1f. Furthermore, the strength of the bent portions 1i of the attachment flange tabs 1f is also considerably increased by the raised edge 1h that is bent at a right angle and extends to the end of the inner panel 1j beyond the bent portion 1i. Accordingly, the attachment flange tabs 1f are resistant to deformation if subjected to vibration or impact, and the angle of the bent portion 1i (i.e., the bending angle) are also resistant to change. The raised edge 1h can be directly connected to the short side panel 1a, or merely be connected to the short side panel 1a via the inner panels 1j and the bottom panel 1b.

The strength of the attachment flange tabs 1f increases as the reinforcing raised edges 1g and 1h become taller. However, if these are too tall, it will be harder to bend the raised edge 1h. Thus, the height of the raised edges 1g and 1h is preferably set to about two to five times the thickness of the sheet metal used as the material of the rear frame 1. For the sake of reference, it was confirmed that if the height of the raised edges 1g and 1h is thus set, the strength of the attachment flange tabs if will be at least 40% higher than the strength of attachment flanges produced by conventional drawing.

As illustrated in FIG. 5, notches 1m are formed at both ends of the short side panels 1a along the mutually opposing short sides of the rear frame 1. The notches 1m are formed such that the short side panels 1a and the raised edge 1h defining a gap therebetween. It is preferable for these notches 1m to be formed because they allow the bending of the attachment flange tabs 1f to be performed more easily by the bending apparatus.

As illustrated in FIGS. 1 and 2, each of the short bezels 9b has a pair of recesses 9c. The recesses 9c are formed at end portions of each of the short bezels 9b, respectively. In particular, the recesses 9c are formed at two corners at both end portions of each of the short bezels 9b. The end portions of the short bezels 9b are bent at a right angle toward the long bezels 9a, respectively. The recesses 9c are aligned with the fastener insertion holes 1k of the attachment flange tabs 1f of the rear frame 1 as viewed from center axes of the fastener insertion holes of the attachment flange tabs 1f of the rear frame 1, respectively. The recesses 9c avoid the attachment flange tabs 1f of the rear frame 1 such that the bosses 14a formed on the rear face of the front cabinet 14 are fitted into and disposed through the recesses 9c and are superposed with the attachment flange tabs 1f, respectively. The bosses 14a of the front cabinet 14 and the attachment flange tabs 1f are fixed together by the screws 16 (e.g., fasteners). In particular, as illustrated in FIG. 5, the screws 16 are inserted through the fastener insertion holes 1k of the attachment flange tabs 1f from below, and then threaded into the threaded holes of the bosses 14a of the front cabinet 14 to fixedly couple the liquid crystal module 12 to the opening of the front cabinet 14.

With the liquid crystal module 12, the attachment flange tabs 1f formed at both ends of the double-walled side panels 1c are not flange tabs that are merely bent outward at a right angle. Instead, the strength of the attachment flange tabs 1f themselves is increased by the raised edges 1g and 1h formed at both side ends of the attachment flange tabs 1f. Furthermore, the strength of the bent portions 1i of the attachment flange tabs 1f is also increased by the raised edges 1h that are bent at a right angle and extend to the ends of the inner panels 1j of the double-walled side panels 1c. Thus, even if subjected to vibration or impact during transport, the attachment flange tabs 1f themselves will be resistant to deformation, and the angle of the bent portions 1i will also be resistant to change. Accordingly, the work of assembly of the liquid crystal module 12 and its attachment to the cabinet 13 can be carried out more easily and accurately. Furthermore, deformation or a change in the bending angle of the attachment flange tabs 1f and so forth will be less likely to occur during assembly of the liquid crystal module 12. As a result, the yield will be higher and the cost can be effectively reduced.

Furthermore, the attachment flange tabs 1f are formed by merely bending at a right angle, which allows the height of the attachment flange tabs 1f to be freely adjusted just by changing the position of the bent portions 1i thereof. Thus, the problem that the attachment height of a liquid crystal module with respect to a cabinet of a display device is limited, as with the attachment flange produced by conventional drawing, can also be eliminated.

Furthermore, the notches 1m are provided at both ends of the short side panels 1a along the short sides of the rear frame 1. Thus, the notches 1m can be used to perform bending more easily when forming the attachment flange tabs 1f by bending the two ends of the short side panels 1a along the long sides of the rear frame 1.

### GENERAL INTERPRETATION OF TERMS

In understanding the scope of the present invention, the term “comprising” and its derivatives, as used herein, are intended to be open ended terms that specify the presence of the stated features, elements, components and groups, but do not exclude the presence of other unstated features, elements, components and groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a liquid crystal module equipped with the present invention. Accordingly, these terms, as utilized to describe the present invention should be interpreted relative to a liquid crystal module equipped with the present invention as used in the normal operating position.

While a preferred embodiment have been chosen to illustrate the present invention, it will be apparent to those skilled in the art from these disclosures that various changes and modifications can be made herein without departing from the scope of the invention as defined in the appended claims. Furthermore, the foregoing descriptions of the preferred embodiment according to the present invention are provided for illustration only, and not for the purpose of limiting the invention as defined by the appended claims and their equivalents.

What is claimed is:

1. A liquid crystal module comprising:
a rear frame including
a rear panel with a pair of adjacent side edge portions,
a first side panel that extends along one of the adjacent side edge portions of the rear panel and in a forward direction of the rear frame relative to the rear panel,
a top panel that extends along a top edge portion of the first side panel and in an outward direction of the rear frame relative to the first side panel,
an attachment tab that is located at an end portion of the first side panel with respect to a longitudinal direction of the first side panel, the attachment tab having a base plate with a pair of opposite side edges and a fastener insertion hole, the base plate extending perpendicular to the first side panel and in the outward direction of the rear frame relative to the first side panel, and
a first flange that extends perpendicular to the first side panel and the base plate of the attachment tab and along a first side edge of the first side panel and one of the opposite side edges of the base plate of the attachment tab;
a light source disposed inside of the rear frame;
a liquid crystal panel disposed on an opposite side of the light source from the rear panel; and
a bezel disposed around edge portions of the liquid crystal panel.

2. The liquid crystal module according to claim 1, wherein
the rear frame further has a second flange that extends perpendicular to the base plate of the attachment tab and along the other of the opposite side edges of the base plate of the attachment tab.

3. The liquid crystal module according to claim 1, wherein
the base plate of the attachment tab being located in a rearward direction of the rear frame relative to the top panel of the rear frame.

4. The liquid crystal module according to claim 1, wherein
the rear frame further includes a second side panel that extends along the other of the adjacent side edge portions of the rear panel and in the forward direction of the rear frame relative to the rear panel, the second side panel having a notch such that the second side panel and the first flange defining a gap therebetween.

5. The liquid crystal module according to claim 1, wherein
the bezel has a recess at a corner portion of the bezel, the recess being aligned with the fastener insertion hole of the attachment tab of the rear frame as viewed from a center axis of the fastener insertion hole of the attachment tab of the rear frame.

6. A display device comprising:
a cabinet including a front cabinet and a rear cabinet, the front cabinet having a front panel and a boss with a threaded hole, the boss protruding in a rearward direction of the front cabinet relative to the front panel;
a liquid crystal module housed within the cabinet, the liquid crystal module having
a rear frame including
a rear panel with a pair of adjacent side edge portions,
a first side panel that extends along one of the adjacent side edge portions of the rear panel and in a forward direction of the rear frame relative to the rear panel,
a top panel that extends along a top edge portion of the first side panel and in an outward direction of the rear frame relative to the first side panel,
an attachment tab that is located at an end portion of the first side panel with respect to a longitudinal direction of the first side panel, the attachment tab having a base plate with a pair of opposite side edges and a fastener insertion hole, the base plate extending perpendicular to the first side panel and in the outward direction of the rear frame relative to the first side panel, and
a first flange that extends perpendicular to the first side panel and the base plate of the attachment tab and along a first side edge of the first side panel and one of the opposite side edges of the base plate of the attachment tab,
a light source disposed inside of the rear frame,
a liquid crystal panel disposed on an opposite side of the light source from the rear panel, and
a bezel disposed around edge portions of the liquid crystal panel; and
a screw disposed through the fastener insertion hole of the attachment tab of the rear frame, the screw being further fastened to the threaded hole of the boss of the cabinet such that the liquid crystal module is fixedly coupled to the cabinet.

7. The display device according to claim 6, wherein
the rear frame further has a second flange that extends perpendicular to the base plate of the attachment tab and along the other of the opposite side edges of the base plate of the attachment tab.

8. The display device according to claim 6, wherein
the base plate of the attachment tab being located in a rearward direction of the rear frame relative to the top panel of the rear frame.

9. The display device according to claim 6, wherein
the rear frame further includes a second side panel that extends along the other of the adjacent side edge portions of the rear panel and in the forward direction of the rear frame relative to the rear panel, the second side panel having a notch such that the second side panel and the first flange defining a gap therebetween.

10. The display device according to claim 6, wherein
the bezel has a recess at a corner portion of the bezel, the recess being aligned with the fastener insertion hole of the attachment tab of the rear frame as viewed from a center axis of the fastener insertion hole of the attachment tab of the rear frame.
